(19) United States
(12) Patent Application Publication
(10) Pub. No.: US 2025/0256206 A1
(43) Pub. Date: Aug. 14, 2025

(54) Remote competition control and transmission

(71) Applicants: Ewgeniy Oganian, Schwabisch Gmund (DE); ESCS INC., Wilmington, DE (US)

(72) Inventor: Ewgeniy OGANIAN, Schwabisch Gmund (DE)

(21) Appl. No.: 18/702,302

(22) PCT Filed: Oct. 17, 2022
(86) PCT No.: PCT/EP2022/078886

§ 371 Date: Apr. 17, 2024

(30) Foreign Application Priority Data
Oct. 17, 2021 (DE) 102021005159

(51) Int. Cl. A63F 13/48; A63F 13/355; A63F 13/75; A63F 13/77

(52) U.S. Cl. CPC A63F 13/48; A63F 13/355; A63F 13/75; A63F 13/77

(57) ABSTRACT

The present disclosure relates to a method of controlling a remote competition. The method includes providing a frontend to be displayed, instructing the game to initiate a match, determining a result of the match, and controlling the remote competition. The present disclosure further relates to a method of transmitting a remote competition. The method includes displaying a frontend, initiating a match according to a match parameter set, returning a result of the match, and controlling the remote competition.

The present invention relates to a method of controlling a remote competition of a game, a method of transmitting a remote competition of a game, a program product, a device, and a system for remote competition control of a game.

Remote matches are increasingly popular in computer games. For example, a game may allow a player to play a remote match against another player, for instance via on internet connection. A player may wish to take part in a remote competition of a game. For example, a player may play a number of subsequent matches until the player loses a match and exits from the competition.

To enable a remote competition, a developer may implement a remote competition functionality in a game. However, it may require a lot of time and development resources for the developer to implement a remote competition functionality in a game. Further, the remote competition functionality may not reach a desired quality.

Alternatively, to enable a remote competition, an external remote competition operator may operate an external remote competition. For example, players may be required to provide the results of a match to the external remote competition operator after the match, or to comply with further competition rules. Accordingly, the external remote competition operator may provide information on the progress and course of the external remote competition to the players. However, such an external remote competition may require a lot of manual involvement for the external remote competition operator. Further, such an external remote competition may be slow and cumbersome to use for the players.

These problems are overcome by the present disclosure. The invention comprises a method which solves the problem of providing an improved method of controlling a remote competition.

The invention is defined in the independent claims. Dependent claims describe preferred embodiments.

In particular, the present disclosure relates to a method of controlling a remote competition. The method includes providing a frontend to be displayed, instructing the game to initiate a match, determining a result of the match, and controlling the remote competition.

The method includes providing a frontend to be displayed within the game. This way, the game developer does not need to include controls into the game interface and connect the control with a remote competition system. Instead, the game developer may include a call to the universal frontend. Therefore, the method saves time and is less prone to error.

A game is a program, an application, a device, a system, or a combination thereof which allow for some form of competition between users. For example, a game may be a program which assigns a number of points to a user which may be compared to the number of points assigned to another user. As another example, a game may allow two or more users to interact with each other virtually. In one instance, each user may rush to finish a task before the other user, such as to finish a virtual car race, solve an enigma, or find a solution to a mathematical or technical problem. In another instance, the users may interact with each other in a virtual environment, such as a virtual ping pong game or a virtual football game.

The frontend may be displayed as on overlay over the game. The frontend may be hidden or reduced in certain scenarios, for example during a match.

When the frontend is provided using web technologies, the frontend is easily updateable separately from the game. For example, the frontend may be provided by a backend. When the backend is operated by a remote competition operator, the frontend may be updated by the remote competition operator, independent from the developer of the game. Therefore, the frontend may be updated or modified without requiring the player to download or install any update of a game on a client device.

The method further includes instructing the game to initiate a match according to a match parameter set. For example, the game developer may include a hook into the game, such that the backend may pass a match instruction to the game.

When the match instruction includes a match parameter set, the game initiates a match according to the match parameter set. For example, a match parameter set may include a time limit, a difficulty level, a speed level, a size, a callback function and/or a connection parameter. This way, a match may have a configuration as desired for a competition.

In an example of a Tetris game, the match may be a single-player match. In another example of a Go game, the match may be a dual-player match, or a single-player match against a computer opponent. In the example of a race game, the match may be a multi-player match, a dual-player match, or a single-player match against the time or against one or more computer opponents. When the match is a dual-player or multi-player match, the connection parameter may identify a resource for the game to synchronize with the opponents or fellow players. For example, the connection parameter may include a uniform resource identifier of a server, a server URI.

The method further includes determining a result of the match. For example, the game developer may invoke a return function when a match is finished. The return function may be a part of a plugin which the game developer integrates into the game. Alternatively or additionally, when the match parameter set includes a callback function, the game may invoke the callback function when the match is finished. Therefore, the determining may comprise pulling the result from the game, or having the game pass the result on.

The determined result of a match may be a boolean result, for example a variable which can take the status “won” or the status “lost”. The determined result of a match may be a set of result values. For example, the result values may include one or more of: player scores, opponent scores, a match time, a number of laps or rounds, lap times, a best lap time, a high score, a set of remaining playing pieces, a set of play money, a number of tokens, foul play, a number of penalties, identified cheating, and the like.

The method further includes controlling the remote competition. In other words, the operation and progress of the competition is controlled. Thereto, the steps described herein may be executed for a number of players and matches, concurrently and in series. For example, a number of matches may be controlled to take place concurrently. Therefore, it can be avoided that one match would influence another match.

The controlling may include imposing a break after the matches, and initiating one or more further rounds of concurrent matches after the break. Alternatively or additionally, the controlling may include waiting for a last match to end before initiating another round of matches. For example, the controlling may include controlling a game server to prevent matches from beginning or force matches to begin.

The controlling may include drawing players to play together or against each other in a match. Further, the controlling may include eliminating a player based on the determined results, based on chance, or based on both the determined results and chance.

Various embodiments may preferably implement a combination of any of the following features.

In an embodiment, the method further includes receiving a competition parameter set and the controlling includes generating a match parameter set for each of a plurality of matches according to the competition parameter set, and performing the instructing according to the match parameter set and determining for each of the matches.

According to this embodiment, the method includes receiving a competition parameter set from a user.

The competition parameter set may include one or more of: a competition mode, player identities, player requirements, match times, match numbers, competition size, competition name, and competition rules. The competition parameter set may further include competition stages. For example, each of a plurality of competition stages may include one or more separate competition modes.

A competition mode may, for example, be a group phase, where groups of players shall be formed such that every player in a group plays against every other player in the group at least once.

Another example for a competition mode may be a single elimination mode, where pairs of players shall be formed such that every pair plays a match and a succumbing player of the pair is eliminated from the competition. The remaining players shall be paired again for a subsequent round.

Another example for a competition mode may be a double elimination mode, where pairs of players shall be formed in a main bracket such that every pair in the main bracket plays a match and a succumbing player of the pair is a player is moved to a secondary bracket. The remaining players in the main bracket shall be paired again for a subsequent round as before. The players in the secondary bracket shall be paired for a subsequent round where a succumbing player is eliminated from the competition. After a number of rounds, a single remaining player from the main bracket shall play a final match against a single remaining player from the secondary round. In a variant of the double elimination mode, in the case that the single remaining player from the main round succumbs in the final match against the single remaining player from the secondary round, another match between the two players is conducted.

Other examples for a competition mode may be a swiss-system mode, a round-robin mode, or any mode that may be mapped in a systematic way.

The competition parameter set is received from the user. Therein, the user may be a player himself. Alternatively, the user may be an independent operator of a competition, for example a sponsor of a game or an event host. The competition parameter set may be received in the form of a filled form, for example a number of selections from a drop-down menu. Alternatively or additionally, the competition parameter set may be received in a pseudo-code form, for example in a form similar to an XML file. Such a competition parameter set may be compiled by the user based on a pseudo-code syntax. Alternatively, such a competition parameter set may be generated by the user using a tool, for example a graphic software which allows combining visual elements representing a desired competition parameter set.

According to this embodiment, the controlling includes generating a match parameter set for each of a plurality of matches according to the competition parameter set.

According to this embodiment, the controlling includes performing the instructing according to the match parameter set and determining for each of the matches.

In an embodiment, the method further includes receiving player input via the frontend.

In an embodiment, the method further includes receiving a watch signal from the game.

In an embodiment, the method further includes providing competition controls via the frontend.

The present disclosure further relates to a method of controlling a remote competition of a game, said method including displaying a frontend, initiating a match according to a match parameter set, returning a result of the match, and controlling the remote competition. The method may be performed by a client device, for example a device operated by a player.

The method includes displaying a frontend within the game.

Preferably, the frontend is retrieved from a backend in accordance with the disclosure herein.

Preferably, the frontend is retrieved and displayed using web technologies. For example, the frontend may be retrieved using the hypertext transfer protocol, http, and displayed using a web view component, such as a UIWebView component in an operating system, or such as a WebView component in another operating system. Therein, the frontend may be described in hypertext markup language, html, and/or a similar technology, including JavaScript.

When the frontend is retrieved using web technologies, the frontend is easily updateable without updating the game. Therefore, the player may enjoy an improved frontend without being required to download or install any update, in particular a game update. Further, the player may enjoy an updated frontend without having to wait for and being dependent on the developer of a game.

The method further includes initiating a match according to a match parameter set. The method may control the game to initiate the match.

Preferably, the match parameter set is received from a backend. When the match parameter set is received from a backend, a variety of matches may be controlled within a competition, without relying on a player's compliant behavior. The match may be initiated according to further parameters, for example graphic quality parameters or interface parameters, additionally to the match parameter set. In other words, a match parameter set may be received from the backend, while further parameters may be player-defined.

The method further includes returning a result of the match to the backend. The result may be returned to the backend using web technologies, for example using a POST request in http.

The method further includes controlling the remote competition.

In an embodiment, the method further includes transmitting player input.

Preferably, the player input is transmitted from the frontend to a backend. In other words, the player input is received at the frontend and passed on to the backend. The player input may be interpreted, compressed and/or coded before being passed to the backend.

In an embodiment, the method further includes signaling a watch signal from the game.

In an embodiment, the method further includes displaying competition controls on the frontend.

In one embodiment, the game may be an application for providing random information, such as a streaming application, a news application, a sports application, or a gambling game application. In this case, the game may be called a page one application.

In this case, the frontend is provided by a page two application, e.g. a plugin or a module. The page two application is configured to exchange data with the page one application and to exchange data with a network, for example with at least a part of the internet.

In this embodiment, the method may comprise a providing of match controls in the front end by the second application. The match controls may allow a player to initiate a match in the second application, for example a betting match. In other words, the page two application may provide controls for placing one or more bets by the player.

In this embodiment, at least a part of the matches executed by the page one application may correspond to matches according to the page two application. For example, the page one application may execute a roulette simulation. In this example, the page two application may allow placing bets on the results of the roulette simulation. In another example, the page one application may stream video of a tennis competition. In this example, the page two application may allow placing bets on the results of the tennis competition. In another example, the page one application may display a pseudo-random event like a sports event, an auction, an art event, a product presentation, or an unveiling of a secret information. In this example, the page two application may allow placing bets on the outcome of the pseudo-random event.

In this embodiment, the initiating of the match may include initiating the match in the page two application rather than in the page one application. In particular, the page one application may not be controlled by the method at all, e.g. in the case when the page one application is a streaming application for streaming a sports competition. In this case, the controlling relates to the page two application, i.e. matches may be initiated, results determined and a competition controlled for the page two application. The page two application may be controlled in a way corresponding to the page one application. For example, the placing of bets may correspond to the matches according to the page one application. For example, the determining of results of matches in the page two application, e.g. results of bets in the page two application, may correspond to results of matches according to the page one application. For example, the controlling of matches in the page two application, e.g controlling of bets in the page two application, according to competition parameters may correspond to a sequence of matches according to the page one application.

The page two application may allow for communicating with other players according to the page one application. For example, the page two application may be configured to allow a player viewing a tennis match in the page one application to communicate with another player viewing the same tennis match in the page one application. The page two application may allow a player to initiate single matches, e.g. the page two application may allow a placer to place a single bet against a virtual bookmaker. Alternatively, the page two application may allow social matches, e.g the page two application may allow a player to place a bet against or with another player involved in the same match in the page one application.

The present disclosure further relates to a method of transmitting a remote competition of a game, said method including capturing a video feed of the remote competition in the game, storing one of pictures or video snippets based on the video feed, providing the pictures or snippets to a frontend, playing a video feed reconstructed from the pictures or video snippets in the frontend, generating a video stream based on the reconstructed video feed in the frontend, and transmitting the video stream.

The method further includes capturing a video feed of the remote competition in the game.

The method further includes storing one of pictures or video snippets based on the video feed.

The method further includes providing the pictures or snippets to a frontend. Preferably, the frontend comprises a web view instance, such as a UIWebView instance in an operating system, or such as a WebView instance in another operating system. This way, the pictures or video snippets may be passed on, without requiring access to the file system on an operating system level.

The method further includes playing a video feed reconstructed from the pictures or video snippets in the frontend.

The method further includes generating a video stream based on the reconstructed video feed in the frontend.

The method further includes transmitting the video stream.

In a preferable embodiment, the method of transmitting a remote competition as described herein is combined with the method of controlling a remote competition as described herein. For example, a combined method of controlling and transmitting a remote competition may include controlling a remote competition of a plurality of client devices by a backend, and transmitting a video stream from each of a subset of the plurality of client devices to the backend.

The present disclosure further relates to a program product for remote competition control of a game, including a computer readable medium, and program instructions stored on said medium and effective when executing to control the computer, said program instructions causing the computer to perform the method according to any of the embodiments described herein, or a combination thereof.

The present disclosure further relates to a device for remote competition control of a game, including computer data storage elements in the device which store a program, and a CPU operatively communicating with said storage elements. Said storage elements and said CPU cooperate in execution of the program in such a manner that said CPU under the control of the program performs the method according to any of the embodiments described herein, or a combination thereof.

The present disclosure further relates to a system for remote competition control of a game, including at least one device as described herein, and including a backend configured to perform the method of controlling a remote competition according to any of the embodiments described herein, or a combination thereof. The backend may include one or more of any of: computers, in particular server computers, cloud computing instances, computer networks, and distributed computer systems.

In an embodiment of the system, the backend is further configured to receive a video stream from the device, and to distribute the video stream. The video stream may be transmitted by the at least one device to the backend. For example, the video stream may be a video stream showing a match in a competition operated using the backend. The backend may modify the video stream. For example the backend may add a watermark to the video stream, such that the video stream may be identified in the case of unauthorized further distribution. The backend may distribute the video stream using a broadcast channel, for example a television channel. The backend may distribute the video stream individually, for example using a subscription based streaming access.

The present disclosure provides a developer with a way to implement a remote competition functionality easily, quickly and with little resources, to operate competitions automatically without manual involvement. Further, the present disclosure provides a player with a way to take part in a remote competition quickly and easily. Further, the present disclosure provides a user with a way to organize a competition easily, without requiring the game developer to modify the game and without requiring the player to provide results or comply with any further competition rules.

The invention is further described with reference to the following figures:

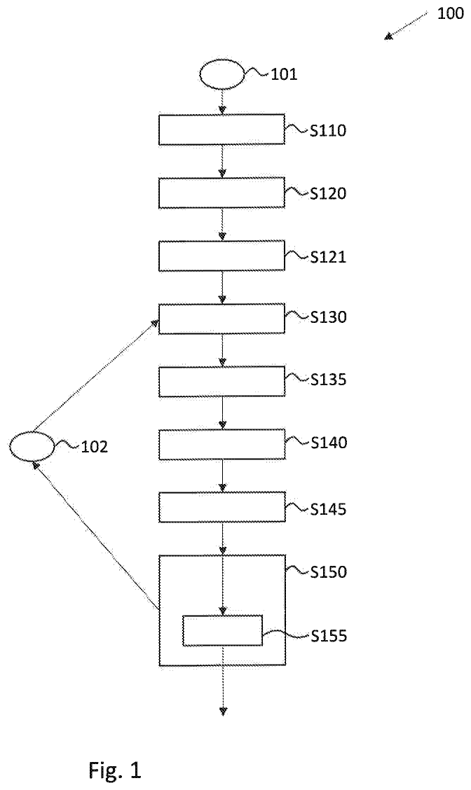

FIG. 1 is a flow diagram of a method of controlling a remote competition according to an embodiment,

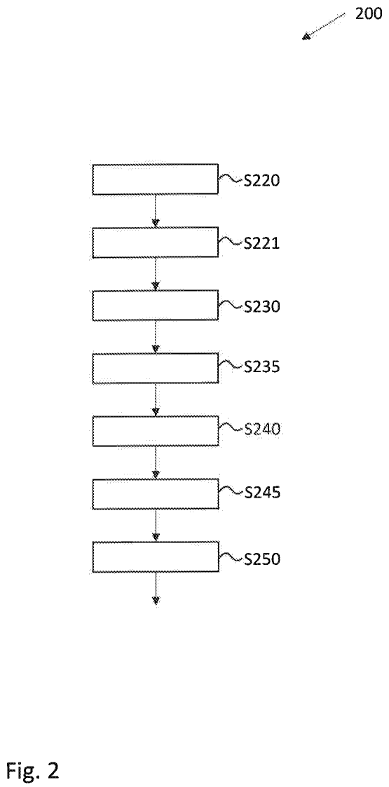

FIG. 2 is a flow diagram of a method of controlling a remote competition according to a further embodiment,

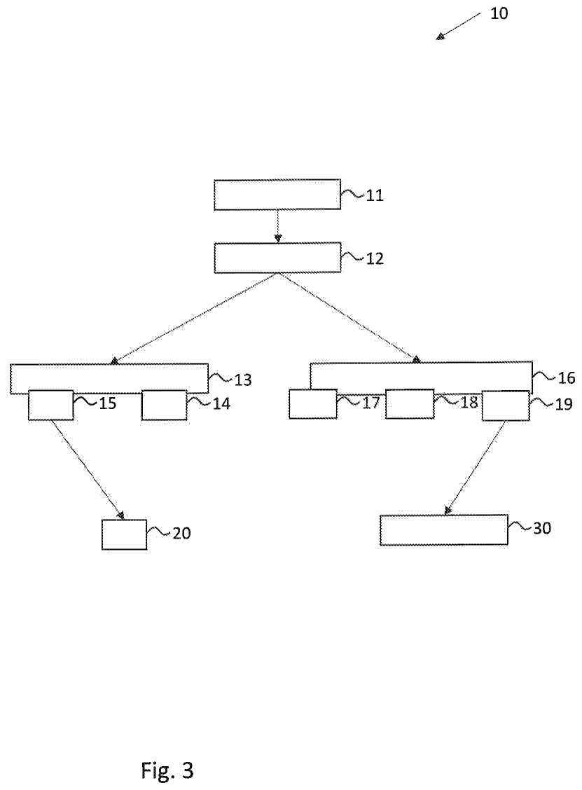

FIG. 3 is a block diagram of a program product for a method of controlling a remote competition according to a further embodiment,

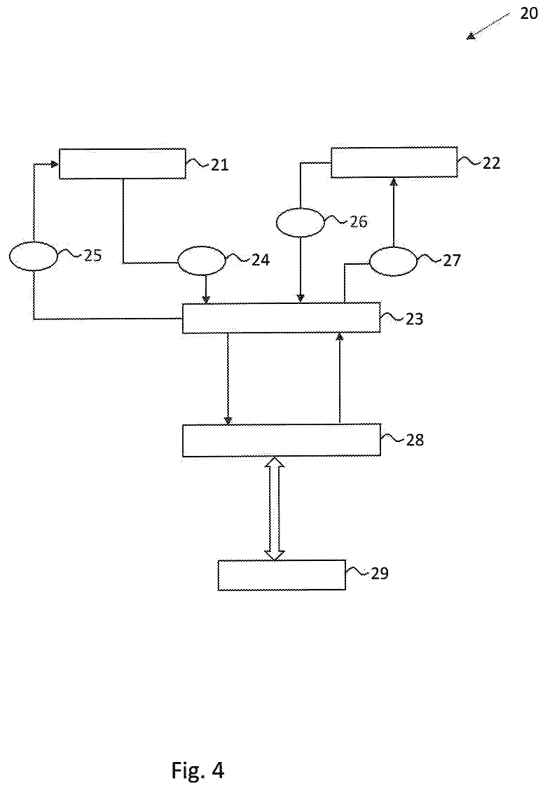

FIG. 4 is a block diagram of a program product for a method of controlling a remote competition according to a further embodiment,

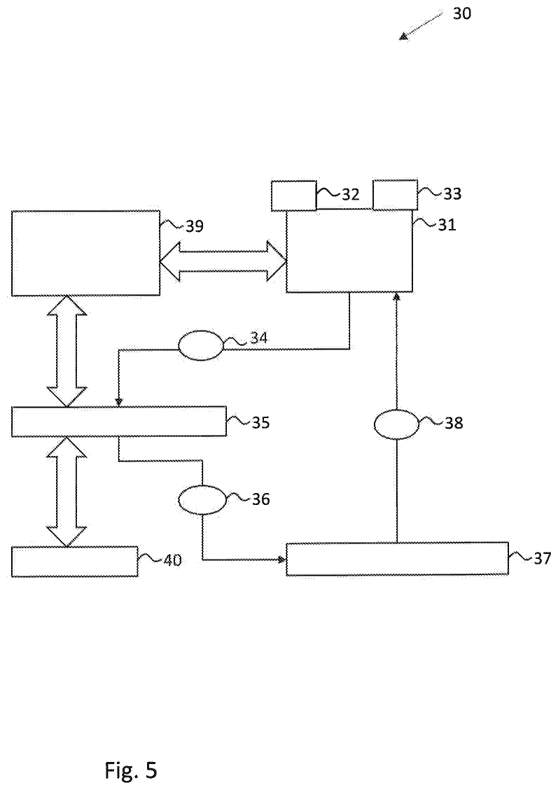

FIG. 5 is a block diagram of a program product for a method of controlling a remote competition according to a further embodiment,

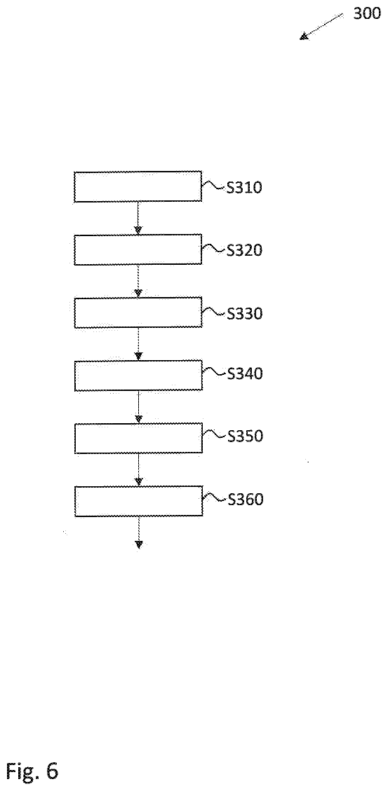

FIG. 6 is a flow diagram of a method of transmitting a remote competition according to an embodiment, and

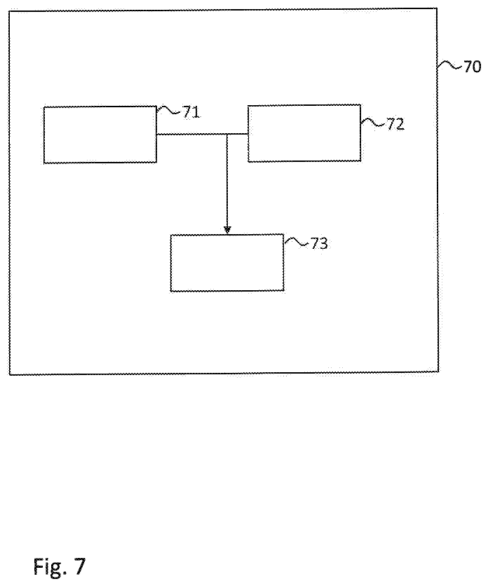

FIG. 7 is a block diagram of an exemplary device according to an embodiment.

FIG. 1 is a flow diagram of a method 100 of controlling a remote competition according to an embodiment. The method may be executed by a backend. For example, the method 100 may be executed by a computer server, by a cloud service, by a distributed computing resource, or by a backend module. The remote competition may be part of a game, e.g. a computer game.

The method comprises a first step S110 of receiving a competition parameter set 101 from a user. In other words, the competition parameter set 101 may be an input to the method. The competition parameter set 101 may for example be provided by a client, e.g. a client computer, a software client or a client module. In some cases, step S110 may be omitted. For example, in a case in which no competition parameter set 101 is available, or the competition parameter set 101 is not provided, step S110 may be omitted and the method may begin with a step S120 of providing a frontend to be displayed.

Step S120 comprises providing a frontend to be displayed within the game.

Preferably the providing uses web technologies. For example, the method displays a frontend using a web view component, such as a UIWebView component in an operating system, or such as a WebView component in another operating system. The details of the frontend to be display such as designs, content and functionality, may be coded using hypertext mark-up language, HTML, Cascading Style Sheets, CSS, Javascript, JPEG and similar web technologies. The frontend may be in communication with a web server, for example using push or pull AJAX technology. Therein, coded details to be displayed on the frontend may be stored and/or retrieved using the hypertext transfer protocol, HTTP, from another device or a network. For example, part of the details may be stored or cached on a device executing the method, and another part of the details may be retrieved, for example from a server.

By using a web view component for displaying a frontend, the method may be implemented in a very universal way, for example using a universal and lightweight plugin which may be easily and quickly integrated into many different games.

The method proceeds with another step S121 of receiving player input via the frontend. This step may be optional or mandatory. The player input can for example include match preferences, team preferences, a ‘player ready’ signal, a

The method proceeds with another step S130 of instructing the game to initiate a match. Preferably, the method initiates the match according to a match parameter set 102, i.e. the method passes the match parameter set 102 to the game. The match parameter set 102 may for example be passed on to the game as a number of parameters. Alternatively, the match parameter set 102 may be passed on to the game as a single string, wherein multiple parameters are encoded in the string, e.g. using JavaScript Object Notation, JSON. The match parameter set 102 may also be passed to the game using a database, e.g. by depositing the parameter set in a database accessed by the game.

The initiating S130 may be synchronized with further instances of the method. For example, the method may wait for a signal before initiating S130 a match, such that a number of matches in a competition are initiated simultaneously, or according to a predetermined time regime.

The method proceeds with another step S135 of receiving a watch signal from the game. The watch signal may include a signal indicating that the match is still ongoing. The watch signal may include a signal indicating that the match parameters have not been changed. The watch signal may include a signal further indicating a current status of the match, such as a current point value, a current race progress, an elapsed time, a health status, a location or position, and/or a current speed. The point value may for example relate to any of health points, hit points, goal counts, a virtual account balance, or the like. The watch signal may be used to identify and/or prevent tempering or cheating. For example, the watch signal may be used to track a point value to identify any impossible or improbable values, changes, change rates, or trajectories.

The watch signal may be provided by the game to the frontend, which may pass the watch signal on to the backend. This way, the watch signal may be implemented in a plugin or module which can be quickly and easily included in any game. Alternatively, the watch signal may be provided by the game to the backend directly.

The method proceeds with another step S140 of determining a result of the match. Step S140 may include comparing or processing match values to determine a result of the match. The determining S140 includes retrieving a result or match values from the client or the game.

Preferably, the result or match values are retrieved from the client, i.e. from a plugin or module. In this case, the method may be implemented in a plugin or module which can be easily and quickly implemented in a game.

The method proceeds with another step S145 of providing competition controls via the frontend. The competition controls are provided by the backend to be displayed via the frontend. For example, the method may provide competition controls to join or leave a team, modify a preference such as a difficulty level, or similar.

The method proceeds with another step S150 of controlling the remote competition. The controlling S150 may be influenced or modified by means of the competition controls provided in the previous step S145.

When the method includes receiving S110 a competition parameter set 101, the controlling S150 may be based on the competition parameter set 101. For example, the competition parameter set 101 may define that the competition is comprised of a predetermined number of matches. In this case, the controlling S150 may include iteratively returning to step S130 of instructing the game to initiate a match, until the predetermined number of matches has been finished. In other examples, the competition may be more flexible and the controlling S150 may be based on the results of one or more matches, on player interaction, and/or include an element of chance.

The controlling S150 may include imposing a break after the matches and initiating one or more further rounds of concurrent matches after the break. Alternatively or additionally, the controlling may include requiring a player to wait for a last match in all or a subset of the matches in a competition to end, before initiating another round of matches. The controlling S150 may be include sending instructions, e.g. break instructions, to the one or more clients. The instructions should be received and implemented by the client, e.g. by a plugin or module executing a method 200 according to FIG. 2. The controlling S150 may also include sending instructions to a game server, e.g. break instructions which may lock the game server and thus prevent clients from playing any matches.

The controlling S150 may include drawing players to play together or against each other in a match. Further, the controlling may include eliminating a player based on the determined results, based on chance, or based on both the determined results and chance.

In the present embodiment, the controlling S150 includes a sub-step S155 of generating a match parameter set 102 for each of a plurality of matches according to the competition parameter set 101. In this case, the method returns to the step S130 of instructing the game to initiate a match according to the respective match parameter set 102 for each of the plurality of matches. In this case, the controlling S150 is at least based on the results of the plurality of matches.

FIG. 2 is a flow diagram of a method of controlling a remote competition according to a further embodiment. The method may be executed by a client. For example, the method 200 may be executed by a client device such as a mobile phone, tablet, notebook, gaming console, personal computer, or a cloud gaming device. In particular, the method may be implemented using a plugin or a module which may be integrated into a game. Alternatively, the method may be implemented using a framework, a sandbox, a virtualization environment, or a module which may at least partly have control over a game. The remote competition may be part of a game, e.g. a computer game.

The method comprises a first step S220 of displaying a frontend within the game. The frontend may be displayed using web technologies, for example as described before regarding step S120 in FIG. 1. Preferably, the frontend is at least partly retrieved from a backend, for example as described before regarding step S120 in FIG. 1. This is particularly easy and effective when the frontend is displayed using web technologies.

The method proceeds with another step S221 of transmitting player input. In particular, the method may include transmitting S221 player input from the frontend to the backend.

The method proceeds with another step S230 of initiating a match according to a match parameter set 102. The match parameter set 102 may be received from the backend, for example as described before regarding step S150 in FIG. 1.

The method proceeds with another step S235 of signaling a watch signal from the game.

The method proceeds with another step S240 of returning a result of the match to the backend. The result may be calculated based on match values, e.g. hit points, health points, goal counts, lap times, or the like. Alternatively, the result itself may include hit points, health points, goal counts, lap times, or the like. The result or match values may be provided by the game. In this case, the method includes retrieving the result or match values from the game. Alternatively, the method may determine the result or match values independently of the game, e.g. by measuring a time until the match is finished.

The result or match values may be provided by the game to the client using a callback function. In this case, the game has full control over which parameters it provides the result or match values. This way, the method may be implemented in a plugin or a module, which may very easily and quickly be integrated into many games. Alternatively or additionally, the method may include observing the result or match values indirectly, e.g. by grabbing a display content of the game. In this case, optical character recognition, OCR, may be performed on a screenshot or screencast retrieved to identify a result or match values. This way, the handover process of the results may be harder to tamper with, or the method may be capable of double-checking the results using at least two sources.

Part of the match values may be collected during the match, such that a trajectory of match values may be generated. This way, a plausibility of the match values may be checked. This way, cheating may be identified and/or prevented.

The method proceeds with another step S245 of displaying competition controls on the frontend. The competition controls retrieve input from the player, which is provided to the backend. Additionally, the input from the player may be processed by the client which executes the frontend, and/or used to modify the game. For example, the method may provide competition controls to join or leave a team, modify a preference such as a difficulty level, or similar.

The method proceeds with another step S250 of controlling the remote competition. Step S250 may include receiving instructions from the backend. Alternatively or additionally, the controlling S250 may be performed according to the competition parameters 101, for example according to a competition mode indicated by the competition parameters 101.

The controlling S250 may include imposing a break after a match, and initiating one or more further rounds of concurrent matches after the break, for example according to competition parameters 101 or for example according to instructions from the backend. Alternatively or additionally, the controlling may include waiting for a last match to end before initiating another round of matches.

The controlling S250 may include connecting players to play together or against each other in a match, for example according to instructions the backend may send in controlling S150 the remote competition. Further, the controlling S250 may include eliminating a player based on any of the determined results, chance, competition parameters, player input, and/or instructions from the backend.

FIG. 3 is a block diagram of a program product for a method of controlling a remote competition according to a further embodiment.

The block diagram shows a structure of a program product 10, which may be called a plugin 10, for a game engine 11. The program product 10 may be configured to perform the method 200 according to FIG. 2. The game engine 11 may, for example, be a Unity game engine. Using the plugin 10, the functionality of method 200 may easily and quickly be integrated into any game which is based on the game engine 11.

The diagram shows the game engine 11, which connects to the plugin 10 using a common game engine interface 12. This way, a single interface between the plugin 10 and the game engine 11 may be sufficient even when the plugin 10 needs to include alternative components, for example for different operating systems supported by the game engine 11. For example, a first operating system may be an Android operating system, and a second operating system may be an iOS operating system.

The common game engine interface 12 communicates with a first component 13 for a first operating system. A first component 13 may include specific wrappers, types and classes used to implement the functionality according to method 200 in combination with a first operating system. The first component 13 communicates with the common game engine interface 12 to facilitate communication between the game based on the game engine 11, and the plugin 10.

The first component 13 includes a first editor 14, which manages software dependencies and manages hardware acceleration for a web view component. The first editor 14 may include an extensible markup language, .xml, file for managing dependencies, and/or a C # file for managing hardware acceleration for the web view component.

Further the first component 13 includes an app lifecycle element 15, which manages calls to a first native plugin 20. The app lifecycle element 15 may be an android archive library, .aar, file. The first native plugin 20 includes an executable binary compatible with the first operating system, configured to provide the functionality according to method 200. A structure of the first native plugin 20 according to one embodiment is shown in FIG. 4.

The common game engine interface 12 communicates with a second component 16 for a second operating system. A second component 16 may include specific wrappers, types and classes used to implement the functionality according to method 200 in combination with a second operating system. The second component 16 communicates with the common game engine interface 12 to facilitate communication between the game based on the game engine 11, and the plugin 10.

The second component 16 includes a second editor 17, which manages a postprocessing of the software project according to the second component 16, for example postprocessing of an Xcode project for compiling Swift code correctly. The second editor 17 may include a C # file for managing the postprocessing.

Further the second component 16 includes a dummy element 18, which forces the developing environment, for example the Xcode compiler, to generate Objective-C/Swift cross-headers. This way, a functionality of the hybrid structure of plugin 10 is maintained, wherein code for different operating systems is combined.

Further the second component 16 includes a lifecycle element 19, which manages calls to a second native plugin 30. The app lifecycle element 19 may be an Objective-C++ source file, an. mm file. The second native plugin 30 includes an executable binary compatible with the second operating system, configured to provide the functionality according to method 200. A structure of the second native plugin 30 according to one embodiment is shown in FIG. 5.

By using such a structure, the plugin 10 is very flexible and may easily and quickly be included into a multi-platform game based on a popular game engine. Therefore, for a game developer a very easy and efficient way is provided to create a game with remote competition functionality. Further, a plugin with such a structure is highly maintainable and flexible, such that the plugin may be kept up-to-date cost-efficiently and quickly.

FIG. 3 may also show a structure of a page two application 10 as described before.

FIG. 4 is a block diagram of a program product 20 for a method of controlling a remote competition according to a further embodiment. In particular, FIG. 4 shows an example of a first native plugin 20 as shown in FIG. 3.

The first native plugin 20 comprises a first button element 21, which allows a player to enable a frontend from within the game. The frontend is provided by a web view element 22, which leverages a web view functionality provided by the operating system. Both the first button element 21 and the web view element 22 may be registered implicitly to a view inside any preferred activity in the game. The first native plugin 20 further comprises a publish-subscribe element 23, which may act as a message intermediary for a system of event producers and consumers, called publishers and subscribers.

The first button element 21 may inform the publish-subscribe element 23 in a message 24 when the position of the button was changed, e.g. due to a player interaction. The publish-subscribe element 23 may inform the first button element 21 in a message 25 when the button should be moved to the top of a view.

The web view element 22 may inform the publish-subscribe element 23 in a message 26 when the web view was closed. The publish-subscribe element 23 may inform the web view element 22 in a message 27 when it should invoke the frontend.

The publish-subscribe element 23 integrates the interface elements 21 and 22 with a service element 28. The service element 28 may be registered in an activity different from the activity to which the first button element 21 and the web view element 22 are registered.

The service element 28 further provides communication to a first network layer 29, which implements various methods for exchanging data with a network, particularly with at least a part of the internet. The first network layer 29 may, for instance, include Retrofit elements, OkHttp elements, and Kotlin coroutines.

By this structure, the first native plugin 20 provides a very flexible frontend, which is present just where and when a player can use it, and integrates smoothly with the game. At the same time, a prompt and fluid messaging and communication is achieved.

FIG. 5 is a block diagram of a program product 30 for a method of controlling a remote competition according to a further embodiment. In particular, FIG. 5 shows an example of a second native plugin 30 as shown in FIG. 3.

The second native plugin 30 comprises a view controller 31, which includes a second button element 32 and a WebView element 33. The WebView element 33 connects to a web view functionality of an operating system, similar to the web view element 22 shown in FIG. 4. The view controller 31 manages the second button element 32, which provides a way for a player to access the frontend at any time when interacting with the game, and the WebView element 33, which is configured to display the frontend.

Further, the second native plugin 30 may send player interaction messages 34 retrieved in the WebView element 33 to a view model element 35. The view model element 35 may send data impact messages 36 to an observable value store 37. In turn, the observable value store 37 may send UI notification messages 38 to the view controller 31.

The view model element 35 may send data impact messages 36 based on a data exchange with a second network layer 40, which relays data from a network, in particular from at least a part of the internet, to the second native plugin 30.

The view model element 35 and the view controller 31 exchange date with a service wrapper element 39. The service wrapper element 39 exposes methods for the client and returns a ViewController element, which is not depicted in the figure. The ViewController element may be added, by the client, to the view controller 31 as a child view controller.

FIG. 6 is a flow diagram of a method 300 of transmitting a remote competition according to an embodiment. The method may be implemented in a plugin, for example a remote competition plugin 10 in a game. The method may be executed on a client device, such as a mobile phone, tablet, notebook, gaming console, personal computer, or a cloud gaming device.

The method comprises a first step S310 of capturing a video feed of the remote competition in the game. Most operating systems provide at least a method for capturing a video feed of the display content. However, no possibility to extract this video feed out of the application is known,

The method proceeds with another step S320 of storing one of pictures or video snippets based on the video feed. The video feed is dissected into single pictures or short video snippets of between 0.5 s and 4 s, preferably between 1 s and 3 s, even more preferably between 1.5 d and 2.5 s length.

The method proceeds with another step S330 of providing the pictures or snippets to a frontend. Preferably, the frontend is a web view element 22, 33. In this case, privileges of the web view element 22, 33 when it comes to interacting with the game may be utilized. Therefore, the pictures or snippets may be extracted from the game application even on locked-down operating systems which impose heavy limitations on cross-application data exchange.

The method proceeds with another step S340 of playing a video feed reconstructed from the pictures or video snippets in the frontend. In a preferable embodiment, the video feed is played in a web view instance which is invisible to the player.

When pictures are provided to the frontend, the video feed may be reconstructed by regularly replacing a picture in the web view instance with a more recent picture, for example twenty-five times a second.

When video snippets were provided to the frontend, the video feed may be reconstructed by regularly replacing a video snippet in the web view instance with a more recent video snippet, as soon as the video snippet has been played back.

The video feed is delayed slightly against the game display to allow for pictures or video snippets to be buffered. Thereby, jitter and video interruptions are avoided.

The method proceeds with another step S350 of generating a video stream based on the reconstructed video feed in the frontend. The web view elements 22, 33 provide methods for generating a video stream based on content displayed within the web view element 22, 33. Thereby, the exception applied to web view elements 22, 33 may be utilized to extract a video feed from a gaming application, which would otherwise not be possible.

The method proceeds with another step S360 of transmitting the video stream. The video stream generated in the web view 22, 33 is free to be transmitted to any internet resource. Preferably, the video stream is transmitted to a broadcasting server via an encrypted connection. This way, the video stream may be kept exclusive and may be broadcasted in a controlled way. Thereby, the video stream from the game may be a resource for, for example, a remote competition provider.

FIG. 7 is a block diagram of an exemplary device 70 according to an embodiment. The device 70 may be a client device, such as a mobile phone, tablet, notebook, gaming console, personal computer, or a cloud gaming device. The device 70 may also be a backend device, such as a server computer, a cloud service device, a backend network device, or a backend module. The device 70 comprises a storage 71, a communication interface 72, and a processor 73.

The device 70 may be configured to execute a program product for a backend as described above with regard to FIG. 1. Alternatively or additionally, the device 70 may be configured to execute a program product for a client as described above with regard to FIGS. 2-5. Alternatively or additionally, the device 70 may be configured to execute a program product for a video streaming function as described above with regard to FIG. 6. The program product may be stored on the storage 71, respectively. The program product may be executed by the processor 73, respectively.

The communication interface 72 may be an interface that is coupled to a network and transmit and receive instructions, competition parameter sets 101, match parameter sets 102, and video streams.

When the device 70 is configured as a backend device, the communication interface 72 may receive match values obtained by the one or more clients. As shown in FIG. 7, the storage 71 is coupled to the communication interface 72 and stores, for example, the match values, the competition parameter sets 101, the match parameter sets 102, the results, and the instructions received by the communication interface 72. The storage 71 may include one or more different types of storage, such as hard disk drive storage, nonvolatile memory, and volatile memory such as dynamic random-access memory. In some embodiments, the storage 71 stores statistics of the competition. The storage 71 may also store a video stream of one or more of the games.

Referring to FIG. 7, the processor 73 may be coupled to the communication interface 72 and the storage 71. The processor 73 may be a microprocessor, a microcontroller, a digital signal processor, or a central processing unit. The term processor may refer to a device having two or more processing units or elements, e.g. a CPU with multiple processing cores. The processor 73 may be used to control the operations of device 70 by executing software instructions or code stored in the storage 71. In some embodiments, the processor 73 may perform the steps of the methods described with regard to FIGS. 1, 2 and 6. When the processor 73 is instructed to retrieve information from another device or transmit information to another device, the processor 73 may signal to the communication interface 72 to retrieve or transmit the information.

According to the present disclosure, a method is provided which allows a developer to implement a remote competition functionality easily, quickly and with little resources, to operate competitions automatically without manual involvement. Further, a method is provided which allows a player to take part in a remote competition quickly and easily. Further, a method is provided which allows a user to organize a competition easily, without requiring the game developer to modify the game and without requiring the player to provide results or comply with any further competition rules.

Other aspects, features, and advantages will be apparent from the summary above, as well as from the description that follows, including the figures and the claims.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

Furthermore, in the claims the word “comprising” does not exclude other elements or steps, and the indefinite article “a” or “an” does not exclude a plurality. A single unit may fulfil the functions of several features recited in the claims. The terms “essentially”, “about”, “approximately” and the like in connection with an attribute or a value particularly also define 10 exactly the attribute or exactly the value, respectively. Any reference signs in the claims should not be construed as limiting the scope.

### REFERENCE SIGNS

10 program product, plugin, page two application
11 game engine, page one application
12 common game engine interface
13 first component
14 first editor
15 app lifecycle element
16 second component
17 second editor
18 dummy element
19 app lifecycle element
20 first native plugin
21 first button element
22 web view element
23 publish-subscribe element
24 message
25 message
26 message
27 message
28 service element
29 first network layer
30 second native plugin
31 view controller
32 second button element
33 WebView element
34 player interaction messages
35 view model element
36 data impact messages
37 observable value store
38 UI notification messages
39 service wrapper element
40 second network layer
70 device
71 storage
72 communication interface
73 processor
100 method
101 competition parameter set
102 match parameter set
S110 receiving step
S120 providing step
S121 receiving step
S130 instructing step
S135 receiving step
S140 determining step
S145 providing step
S150 controlling step
S155 generating step
200 method
S220 displaying step
S221 transmitting step
S230 initiating step
S235 signaling step
S240 returning step
S245 displaying step
S250 controlling step
300 method

S310 capturing step

S320 storing step

S330 providing step
S340 playing step

S350 generating step

S360 transmitting step

1. A method of controlling a remote competition of a game, said method including:
providing (S120) a frontend to be displayed;
instructing (S130) the game to initiate a match;
determining (S140) a result of the match; and
controlling (S150) the remote competition.

2. The method according to claim 1, further including:
receiving (S110) a competition parameter set (101);
wherein the controlling (S150) includes generating (S155) a match parameter set (102) for each of a plurality of matches according to the competition parameter set (101), and performing the instructing (S130) according to the match parameter set (102) and determining (S140) for each of the matches.

3. The method according to claim 1, further comprising:
receiving (S121) player input via the frontend.

4. The method according to claim 1, further comprising:
receiving (S135) a watch signal from the game.

5. The method according to claim 1, further comprising:
providing (S145) competition controls via the frontend.

6. A Method of controlling a remote competition of a game, said method comprising:
displaying (S220) a frontend;
initiating (S230) a match according to a match parameter set (102);
returning (S240) a result of the match; and
controlling (S250) the remote competition.

7. The method according to claim 6, further comprising transmitting (S221) player input.

8. The method according to claim 6, further comprising signaling (S235) a watch signal from the game.

9. The method according to claim 6, further comprising displaying (S245) competition controls on the frontend.

10. Method of transmitting a remote competition of a game, said method comprising:
capturing (S310) a video feed of the remote competition in the game;
storing (S320) one of pictures or video snippets based on the video feed;
providing (S330) the pictures or snippets to a frontend;
playing (S340) a video feed reconstructed from the pictures or video snippets in the frontend;
generating (S350) a video stream based on the reconstructed video feed in the frontend; and
transmitting (S360) the video stream.

11. The method according to claim 2, further comprising: receiving (S121) player input via the frontend.

12. The method according to claim 2 further comprising: receiving (S135) a watch signal from the game.

13. The method according to claim 2, further comprising: providing (S145) competition controls via the frontend.

14. The method according to claim 3 further comprising: receiving (S135) a watch signal from the game.

15. The method according to claim 3, further comprising: providing (S145) competition controls via the frontend.

16. The method according to claim 4, further comprising: providing (S145) competition controls via the frontend.

17. The method according to claim 7, further comprising signaling (S235) a watch signal from the game.

18. The method according to claim 7, further comprising displaying (S245) competition controls on the frontend.

19. The method according to claim 8, further comprising displaying (S245) competition controls on the frontend.
